(19) United States
(12) Patent Application Publication
(10) Pub. No.: US 2009/0155750 A1
(43) Pub. Date: Jun. 18, 2009

(54) ELECTRONIC DICTIONARY DEVICE WITH A HANDWRITING INPUT FUNCTION

(75) Inventor: Takatoshi ABE, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/331,640

(22) Filed: Dec. 10, 2008

(30) Foreign Application Priority Data
Dec. 12, 2007 (JP) 2007-321099

(51) Int. Cl. G09B 5/02; G06F 17/21

(52) U.S. Cl. 434/169; 704/10

(57) ABSTRACT

In a state where an explanatory information display screen corresponding to a desired entry word is displayed on a touch panel display unit, the front area and reverse area of a rote card to be created on the screen are displayed. In this state, the user selects the areas sequentially with a cursor and inputs on a handwriting input unit an entry word and explanatory information corresponding to the entry word in handwritten characters. The handwritten entry word and explanatory information are displayed in the front area and reverse area and registered in a RAM as a single rote card. A plurality of registered rote card data items are displayed in list form. A desired rote card is selected and the display is suitably switched between the front data (entry word) and reverse data (explanatory information) of the rote card.

### CROSS-REFERENCE TO RELATED APPLICATIONS

This application is based upon and claims the benefit of priority from prior Japanese Patent Application No. 2007-321099, filed Dec. 12, 2007, the entire contents of which are incorporated herein by reference.

### BACKGROUND OF THE INVENTION

1. Field of the Invention

This invention relates to an electronic dictionary device with a handwriting input function.

2. Description of the Related Art

To help the user memorize an entry word and its explanatory information in a dictionary efficiently, one conventional electronic dictionary device has a display control function of specifying an arbitrary description part in the dictionary beforehand in color and identify the specified part when displaying the dictionary data or to hiding the description part. One example of an electronic dictionary device has been disclosed in, for example, Jpn. Pat. Appln. KOKAI Publication No. 2002-07420.

The electronic dictionary device also has another display control function of displaying a front face and reverse face of a card on which an entry word and its explanatory information in the dictionary have been written, respectively, that is, an image of a rote learning card.

While the conventional electronic dictionary device has a display control function of displaying an entry word and its explanatory information in the form of an image of a rote card, this function simply involves extracting the entry word data and explanatory information data from the dictionary data and pasting the extracted data to image data that imitates a rote card.

Accordingly, although actual rote cards enable the user to obtain a high learning effect by writing an entry word and its explanatory information with the user's own hand at the time of creating the cards, an effect corresponding to this cannot be obtained from the conventional electronic dictionary device.

### BRIEF SUMMARY OF THE INVENTION

It is an object of the invention to provide an electronic dictionary device with a handwriting input function capable of creating handwritten rote cards in a state where an entry word and its explanatory information in the dictionary data are displayed.

The foregoing object is accomplished by providing an electronic dictionary device with a handwriting input function, comprising: dictionary data storage means which stores a plurality of entry words and explanatory information on each of the plurality of entry words in such a manner that the former correspond to the latter; dictionary information display control means which displays on a display unit an arbitrary one selected by the user from the plurality of entry words and explanatory information corresponding to the entry word stored in the dictionary data storage means; handwriting input acceptance means which accepts a handwriting input corresponding to a user operation in a state where the dictionary information display control means has displayed on the display unit the arbitrary entry word and explanatory information corresponding to the entry word; set information storage means which stores set information created by causing a plurality of pieces of handwriting input information accepted by the handwriting input acceptance means to correspond to one another; and set information display control means which displays on the display unit one piece of handwriting input information included in the set information stored in the set information storage means and then displays on the display unit another piece of handwriting input information included in the set information according to a user operation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an appearance configuration of an electronic dictionary device 10 with a handwriting input function according to an embodiment of the invention;

FIG. 2 is a block diagram of the electronic circuitry of the electronic dictionary device 10 with the handwriting input function;

FIG. 3 is a flowchart to help explain a rote card creating process in the electronic dictionary device 10 with the handwriting input function;

FIGS. 4A to 4C show display operation 1 to display operation 3 corresponding to a user operation in the rote card creating process in the electronic dictionary device 10 with the handwriting input function;

FIGS. 5A to 5E show display operation 4 to display operation 8 corresponding to a user operation in the rote card creating process in the electronic dictionary device 10 with the handwriting input function;

FIG. 6 is a flowchart to help explain a rote card browsing process in the electronic dictionary device 10 with the handwriting input function;

FIGS. 7A to 7D show display operation 1 to display operation 4 corresponding to a user operation in the rote card browsing process in the electronic dictionary device 10 with the handwriting input function;

FIG. 8 is a flowchart to help explain a rote card dictation test process in the electronic dictionary device 10 with the handwriting input function;

FIGS. 9A to 9C show display operation 1 to display operation 3 according to a user operation in the rote card dictation test process in the electronic dictionary device 10 with the handwriting input function; and

FIGS. 10A to 10E show display operation 4 to display operation 8 corresponding to a user operation in the rote card dictation test process in the electronic dictionary device 10 with the handwriting input function.

### DETAILED DESCRIPTION OF THE INVENTION

Embodiments according to the present invention will be described in detail with reference to the accompanying drawings. The scope of the claimed invention should not be limited to the examples illustrated in the drawings.

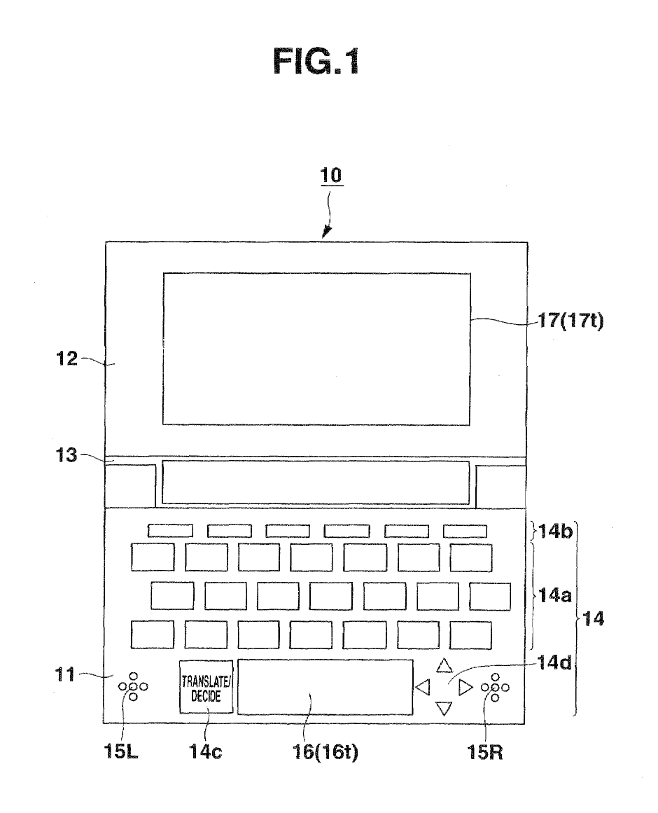

FIG. 1 is a front view showing an appearance configuration of an electronic dictionary device 10 with a handwriting input function according to an embodiment of the invention.

The electronic dictionary device 10 is composed of a body case 11, a lid case 12, and a hinge unit 13 in such a manner that the body case 12 is coupled with the lid case 12 via the hinge unit 13 so as to form a foldable case that can be opened and closed. With the foldable case opened, the body case 11 has an input unit 14 and a pen input unit 16 provided at its surface. The input unit 14 includes character input keys 14a, dictionary specify keys 14b, “Translate/Decide” key 14c, cursor keys 14d, and speakers 15L, 15R.

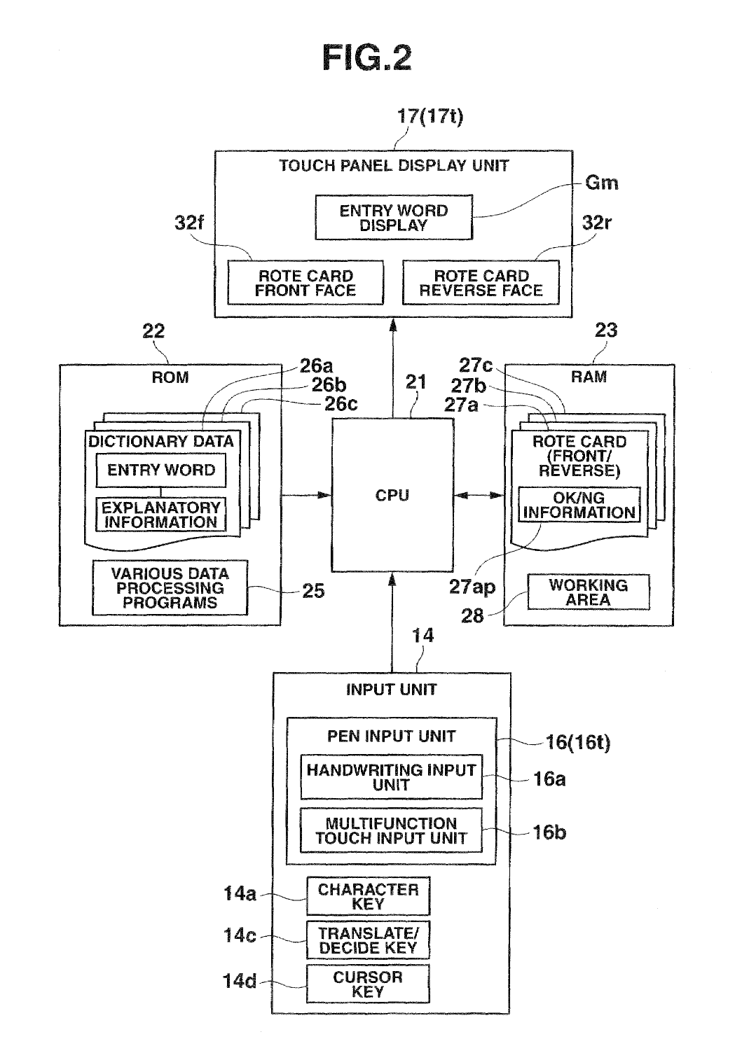

The pen input unit 16 has a structure where a touch position sensing unit which senses the position where the user touches with a pen or his or her finger is integral with a display unit. The pen input unit 16 is so configured that a transparent tablet 16t is laid on, for example, a 256×64 dot liquid-crystal display screen on the front side of the central part of the input unit 14. The input area of the pen input unit 16 is switched to a handwriting input unit 16a for inputting handwritten characters, a multifunction touch input unit 16b, or an area where the input units 16a, 16b are mixed, when it is necessary (see FIG. 2).

The track of the handwriting input in the area where the pen input unit 16 has been switched to the handwriting input unit 16a is reflected in the liquid-crystal display screen and displayed there.

At the surface of the lid case 12, for example, a 480×320 dot touch panel display unit (liquid-crystal display screen) 17 with backlighting is provided to cover almost all the surface. Like the pen input unit 16, the touch panel display unit 17 also has a structure where a touch position sensing unit which senses the position where the user touches with a pen or his or her finger is integral with a display unit. The touch panel display unit 17 is so configured that a transparent tablet 17t is laid on the liquid-crystal display screen.

FIG. 2 is a block diagram of the electronic circuitry of the electronic dictionary device 10 with the handwriting input function.

The electronic dictionary device 10 is composed of a computer which reads programs recorded in various types of storage mediums or transferred programs and whose operation is controlled by the read-in programs. The electronic circuitry of the electronic dictionary device is composed of a CPU (central processing unit) 21.

The CPU 21 controls each section of the circuitry using a RAM 23 as a working memory according to a device control program previously stored in a ROM (flash memory) 22.

The device control program stored in the ROM 22 is activated by an input signal corresponding to a user operation on the input unit 14, pen input unit 16, or touch panel display unit 17.

Connected to the CPU 21 are not only the input unit 14, pen input unit 16, ROM 22, and RAM 23 but also the touch panel display unit 17 and the like.

Stored in the ROM 22 are not only a system program that supervises the entire operation of the electronic dictionary device 10 but also various data processing programs 25.

The various data processing programs 25 include an entry word retrieving program according to the input of a search string, a readout displaying program for various pieces of explanatory information including translated words, semantic contents, and example sentences corresponding to a specified entry word, a rote card creating program for creating rote card data items 27a, 27b, . . . according to the input of handwritten characters on the pen input unit 16 in a state where the explanatory information is read and displayed, a rote card browsing program for selectively displaying rote card data items 27a, 27b, . . . created in the rote card creating process, and a rote card dictation test program for selectively displaying the rote card data items 27a, 27b, . . . created in the rote card creating process and prompting the user to take down the explanatory information corresponding to the entry word written in the card data or the entry word corresponding to the explanatory information on the pen input unit 16.

In the ROM 22, various dictionary data items 26a, 26b, 26c, . . . are stored. The various dictionary data items 26a, 26b, 26c, . . . include not only a Japanese-language dictionary, an English-Japanese dictionary, a Japanese-English dictionary, an English-English dictionary, an English thesaurus, and the like but also different types of dictionary data items, such as “KO**JI” and “KAN**GEN”. They are previously or additionally input and stored.

In the RAM 23, rote card data items 27a, 27b, 27c, . . . created in the rote card creating process are stored. Moreover, a working area 28 that stores various data items input to or output from the CPU 21 as needed according to the various data processes (25) is secured in the RAM 23.

The rote card data items 27a, 27b, 27c, . . . are stored in such a manner that the card data item on the front face of a rote card is related to that on the reverse face. Furthermore, OK/NG information 27ap indicating that the memorization of the contents of the card inputted by the user in the rote card dictation test process is OK or NG is added to each card data item.

In the embodiment, each of the rote card data items 27a, 27b, 27c, . . . stored in the RAM 23 may be stored as card data on a single card. Alternatively, a set of a plurality of card data items, 27a1, 27a2, . . . 27an, 27b1, 27b2, . . . , 27bn, 27c1, 27c2, . . . , 27cn may be included in each of the card data items 27a, 27b, 27c, . . . .

The touch panel display unit 17 displays an entry word display screen Gm which displays in list form the entry words retrieved in the entry word retrieving process or a rote card front area 32f which displays handwritten character data input at the handwriting input unit 16a in the rote card creating process as descriptive data on the rote card front face, and a rote card reverse area 32r which displays the handwritten character data as descriptive data on the rote card reverse face.

Next, the operation of the electronic dictionary device 10 with the handwriting input function will be explained.

(Rote Card Creating Process)

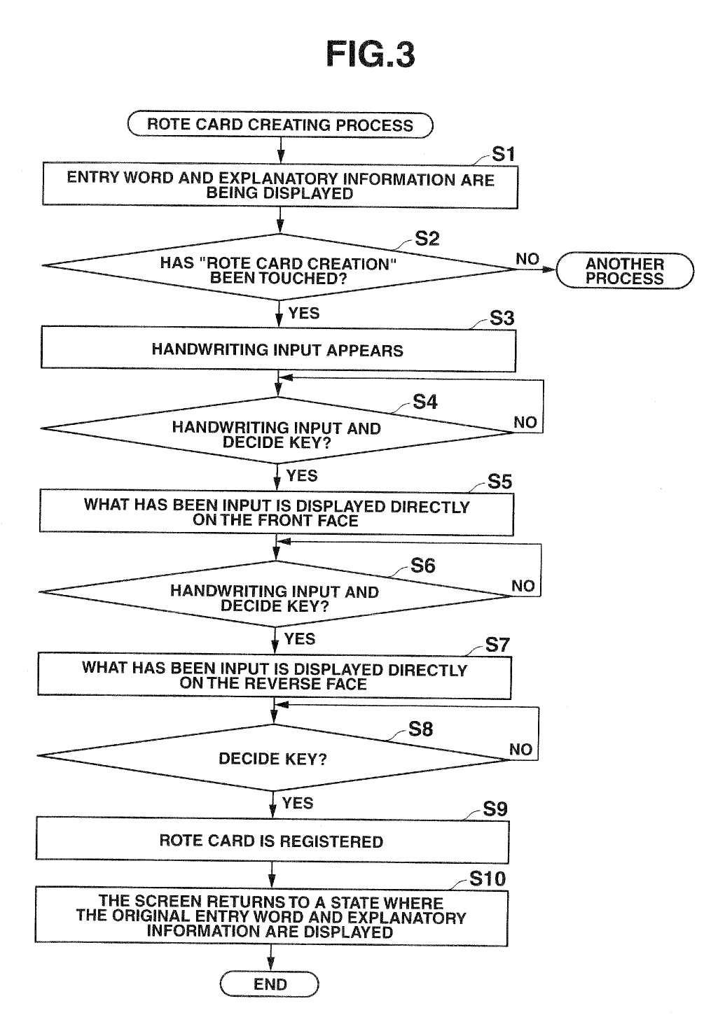

FIG. 3 is a flowchart to help explain a rote card creating process in the electronic dictionary device 10 with the handwriting input function.

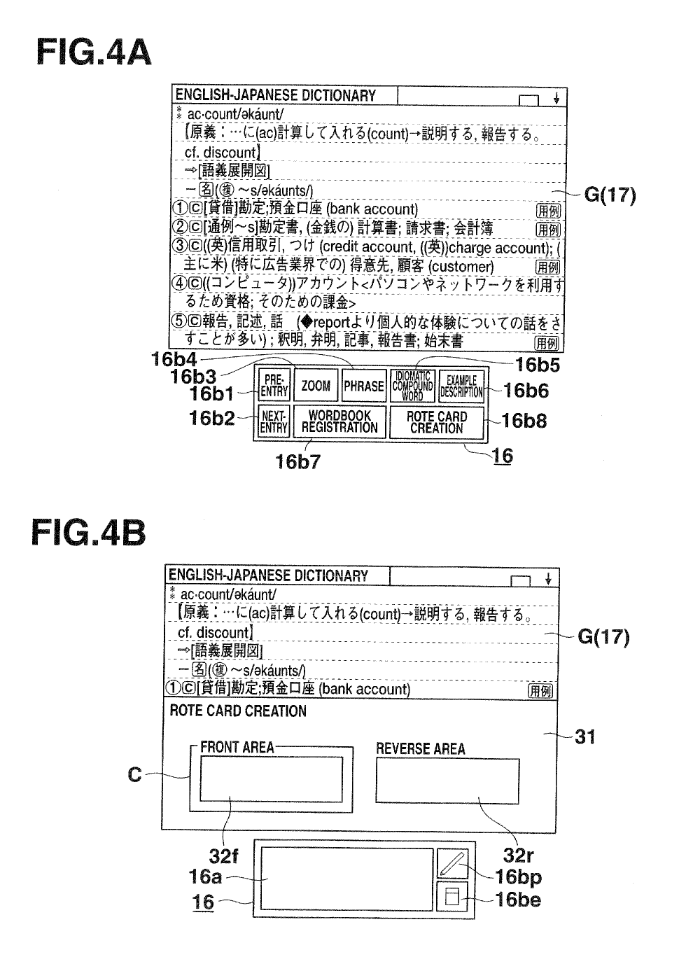

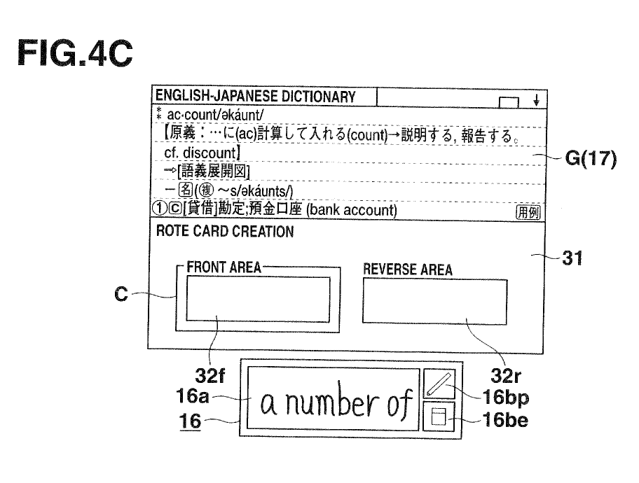

FIGS. 4A to 4C show display operation 1 to display operation 3 corresponding to a user operation in the rote card creating process in the electronic dictionary device 10 with the handwriting input function.

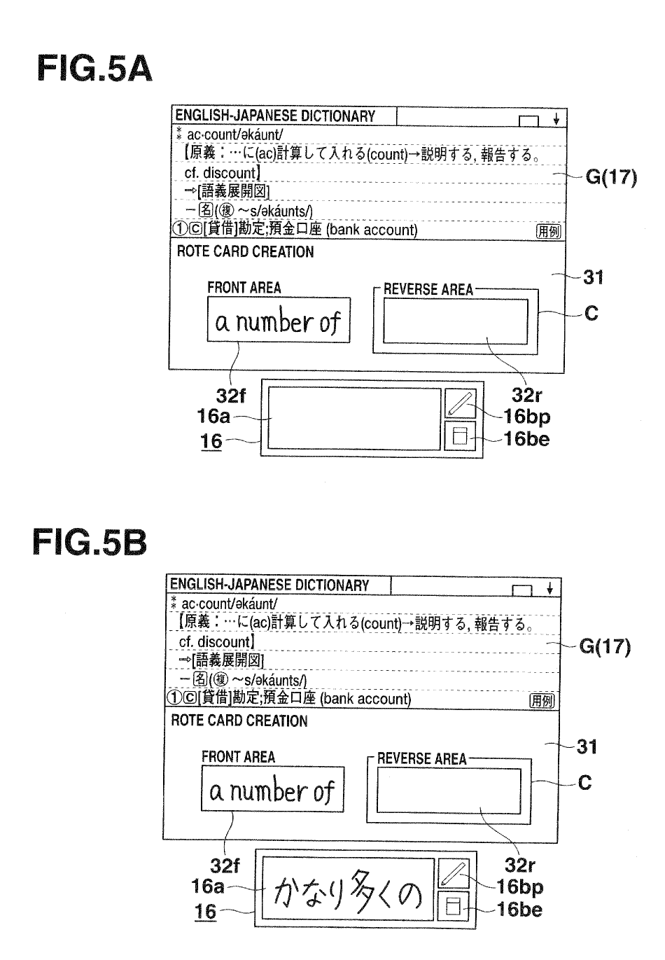

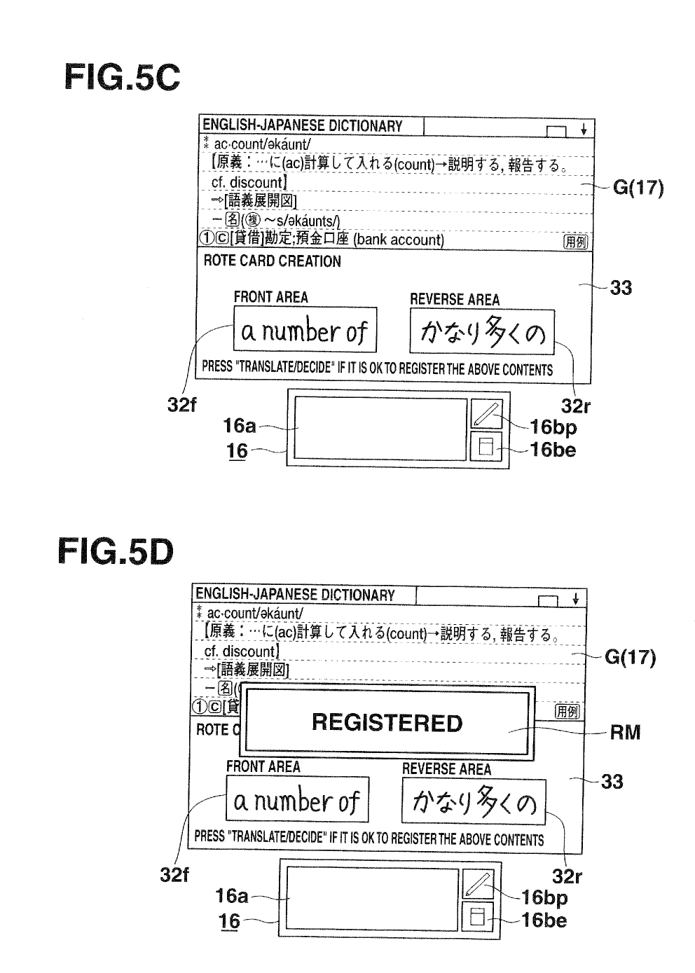

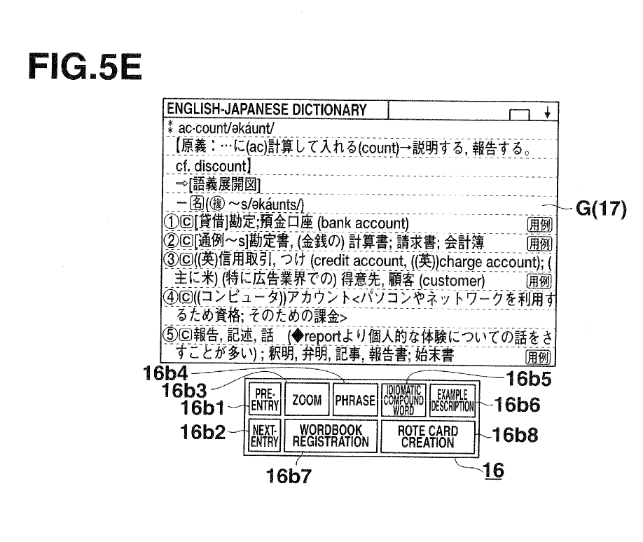

FIGS. 5A to 5E show display operation 4 to display operation 8 corresponding to a user operation in the rote card creating process in the electronic dictionary device 10 with the handwriting input function.

When an arbitrary entry word (e.g., “account”) is retrieved from the dictionary data items 26a, 26b, . . . in an ordinary entry word retrieving process and “Translate/Decide” key 14c is input, explanatory information corresponding to the specified entry word “account” is read out in the explanatory information read and display process and is then displayed on the touch panel display unit 17 in the form of an explanatory information display screen G as shown in FIG. 4A (step S1).

With the explanatory information display screen G being displayed, the following buttons are displayed as the multifunction touch input unit 16b on the pen input unit 16: “Pre-entry” button 16b1, “Next-entry” button 16b2, “Zoom” button 16b3, “Phrase” button 16b4, “Idiomatic Compound Word” button 16b5, “Example Description” button 16b6, “Wordbook Registration” button 16b7, and “Rote Card Creation” button 16b8.

With the explanatory information display screen G corresponding to the user-specified entry word “account” being displayed, when “Rote Card Creation” button 16b8 displayed on the pen input unit 16 is touched and input with a pen (YES in step S2), a rote card creation screen 31 is displayed in the explanatory information display screen G and the rote card front area 32f and rote card reverse area 32r are displayed as shown in FIG. 4B. As a result, the pen input unit 16 is set in the handwriting input unit 16a and “Pen” button 16bp and “Eraser” button 16be are displayed in a part of the right periphery (step S3).

At this time, on the rote card creation screen 31, the rote card front area 32f is enclosed by cursor C and displayed as a default, thereby prompting the user to input handwritten characters to the rote card front area 32f.

Here, as shown in FIG. 4C, when handwritten characters (e.g., entry word “a number of”) desired by the user are input and displayed on the handwriting input unit 16a and “Translate/Decide” key 14c is input (YES in step S4), the input handwritten characters “a number of” are displayed as they are in the rote card front area 32f of the rote card creation screen 31 as shown in FIG. 5A (step S5).

At this time, on the rote card creation screen 31, the position of the cursor C is changed from the rote card front area 32f to the rote card reverse area 32r, thereby prompting the user to input handwritten characters to the rote card reverse area 32r.

Here, when handwritten characters (e.g., explanatory information [symbol] desired by the user are input and displayed on the handwriting input unit 16a as shown in FIG. 5B to input explanatory information corresponding to entry word “a number of” input and displayed in the rote card front area 32f and “Translate/Decide” key 14c is input (YES in step S6), the input handwritten characters [symbol] are displayed as they are in the rote card reverse area 32r of the rote card creation screen 31 as shown in FIG. 5C (step S7).

At this time, when cursor C is erased with the rote card front area 32f and rote card reverse area 32r being displayed, the rote card creation screen 31 is switched to a rote card registration screen 33.

Then, when “Translate/Decide” key 14c is input as shown in FIG. 5D (YES in step S8), rote card data item 27a is created which causes the handwritten characters (entry word) “a number of” input and displayed in the rote card front area 32f in steps S4, S5 and the handwritten characters (explanatory information) [symbol] input and displayed in the rote card reverse area 32r in steps S6, S7 to correspond to front data and reverse data, respectively. The rote card data item 27a is registered in the RAM 23 (step S9).

At this time, on the rote card registration screen 33, the registration completion message “Registered” RM is displayed, thereby informing the user that the registration of rote card data item 27a using the front data “a number of” and reverse data [symbol] has been completed.

Then, after a certain period of time (e.g., one second later), the screen returns to a state where the original explanatory information display screen G is displayed on the touch panel display unit 17 as shown FIG. 5E (step S1).

The series of rote card creating processes (step S1 to step S10) are carried out repeatedly, thereby creating a plurality of user-desired rote card data items 27a, 27b, 27c, . . . sequentially. The rote card data items 27a, 27b, 27c, . . . are then registered in the RAM 23.

In the rote card creating process, setting is done automatically so that the rote card front area 32f of the rote card creation screen 31 may be first enclosed by cursor C and goes into a state where the input of handwritten characters is waited for, and then the rote card reverse area 32r may be enclosed by cursor C and goes into a state where the input of handwritten characters is waited for. In contrast, the rote card creating process may be so configured that whether the rote card front area 32f or the rote card reverse area 32r should be brought into the input waiting state is determined arbitrarily by the user touching either the area 32f or 32r.

Furthermore, in the rote card creating process, two handwriting input data items, front data item and reverse data item, are caused to correspond to each other, thereby creating and registering a single rote card data item 27a. In addition, the rote card creating process may be so configured that three or more handwriting input data items are caused to correspond to one another, thereby creating and registering a single rote card data item 27a.

(Rote Card Browsing Process)

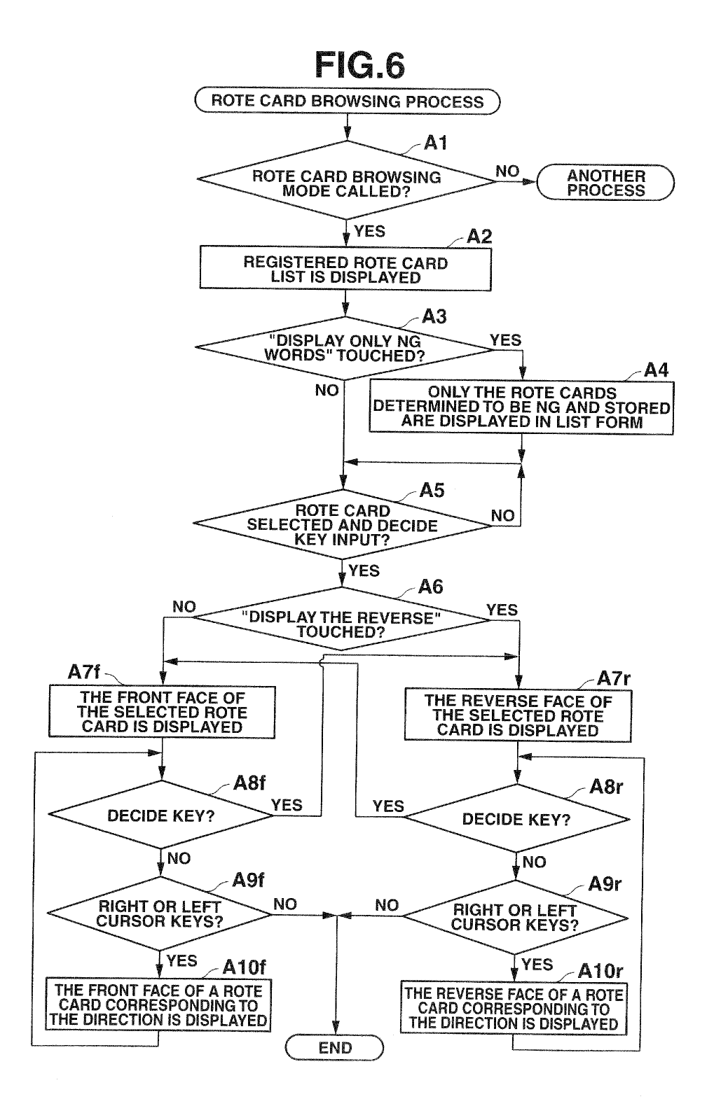

FIG. 6 is a flowchart to help explain a rote card browsing process in the electronic dictionary device 10 with the handwriting input function.

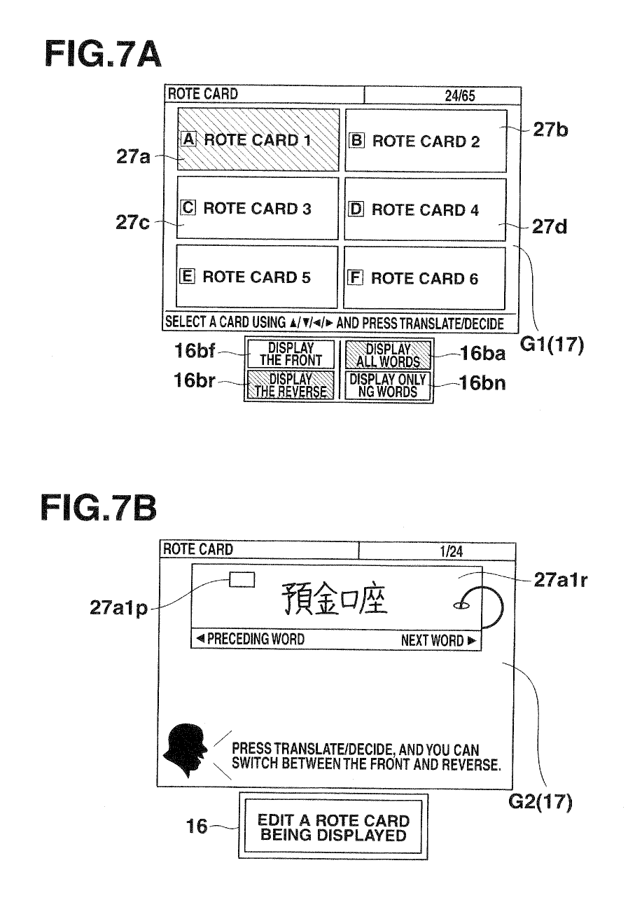

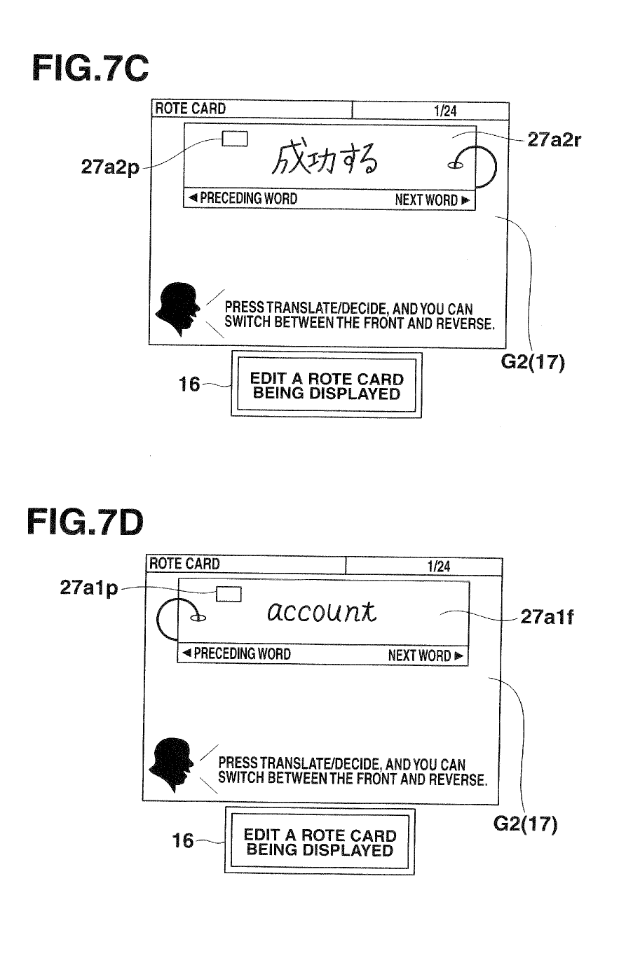

FIGS. 7A to 7D show display operation 1 to display operation 4 corresponding to a user operation in the rote card browsing process in the electronic dictionary device 10 with the handwriting input function.

When the rote card browsing mode is selected according to the key input at the input unit 14 on a menu selection screen (not shown) displayed on the touch panel display unit 17 (step A1), the rote card data items 27a, 27b, 27c, . . . registered in the RAM 23 are read. Then, a rote card list screen G1 where the rote card data items 27a, 27b, 27c, . . . are used as entries, “Rote card 1,” “Rote card 2,” “Rote card 3,” . . . is displayed on the touch panel display unit 17 as shown in FIG. 7A (step A2).

On the rote card list screen G1 of FIG. 7A, “Rote card 1” (27a) has been highlighted and selected by default. The total number of rote card data items registered in the RAM 23 is 65. Of them, 24 rote card data items 27a1 to 27a24 have been registered in the selected “Rote card 1” (27a). With the rote card list screen G1 being displayed, any one of the card entries “Rote card 1” (27a), “Rote card 2” (27b), “Rote card 3” (27c), . . . is input by touching the corresponding rote card or by using the cursor keys 14d, thereby selecting a desired one of the card data items 27a, 27b, 27c, . . . .

With the rote card list screen G1 displayed, “Display the front” button 16bf, “Display the reverse” button 16br, “Display all words” button 16ba, and “Display only NG words” button 16bn are displayed as the multifunction touch input unit 16b on the pen input unit 16.

Here, when “Display only NG words” button 16bn displayed on the pen input unit 16 is touched (step A3), only rote card data items 27a, 27b, . . . to which OK/NG information 27ap indicating rote NG has been added are selected from all the rote card data items 27a, 27b, . . . registered in the RAM 23 and are used as entries on the rote card list screen G1, which is displayed (step A4).

Then, in a state where “Rote card 1” (27a) as shown in FIG. 7a is displayed on the rote card list screen G1 selected by the user's pen touch or the use of the cursor keys 24, when “Translate/Decide” key 14c is input (YES in step A5), it is determined whether “Display the reverse” button 16br on the pen input unit 16 has been touched (step A6).

Here, if it has been determined that “Display the reverse” button 16br on the pen input unit 16 has been touched and selected as shown in FIG. 7A (YES in step A6), the reverse data item (here, handwritten character data serving as explanatory information [symbol] 27a1r in a first rote card data item 27a1 registered so as to correspond to the selected “Rote card 1” (27a) is read out. Then, as shown in FIG. 7B, a card browsing screen G2 showing the reverse face of the rote card on which the reverse data item 27a1r has been written is displayed on the touch panel display unit 17 (step A7r).

At this time, on the rote card displayed on the card browsing screen G2, OK/NG information 27a1p (here, unset) on rote card data item 27a1 written on the card is also displayed.

With the card browsing screen G2 of FIG. 7B being displayed, when a cursor key 14d (“→” key) is input (YES in step A9r), the card browsing screen G2 is switched to another card browsing screen G2 on which the reverse data item [symbol] 27a2r in a second (or next) rote card data item 27a2 registered so as to correspond to the selected “Rote card 1” (27a) has been written as shown in FIG. 7C (step A10r).

With the card browsing screen G2 of FIG. 7C being displayed, when a cursor key 14d (“←” key) is input (YES in step A9r), the card browsing screen G2 is switched to another card browsing screen G2 on which the reverse data item [symbol] 27a1r in a first (or preceding) rote card data item 27a1 registered so as to correspond to the selected “Rote card 1” (27a) has been written as shown in FIG. 7B (step A10r).

Therefore, according to the input of a cursor key 14d (“→” or “←”), the card browsing screen G2 is switched to that for the next rote card or that for the preceding rote card.

Accordingly, in a state where the card browsing screen G2 on which the reverse data of the desired card has been written is displayed, for example, the card browsing screen G2 on which the reverse data item [symbol] 27a1r in rote card data item 27a1 of FIG. 7B has been written is displayed, when “Translate/Decide” key 14c is input (YES in step A8r), the front data item “account” 27a1f in the rote card data item 27a1 currently selected and displayed is read out. Then, as shown in FIG. 7D, a card browsing screen G2 showing the front face of the rote card on which the front data item 27a1f has been written is displayed on the touch panel display unit 17 (step A7f).

In a state where the card browsing screen G2 on which the front data item “account” 27a1f in rote card data item 27a1 has been written is displayed, “Translate/Decide” key 14c is input again (YES in step A8f), the screen returns to the card browsing screen G2 which shows the reverse face of the rote card on which the reverse data item [symbol] 27a1r in rote card data item 27a1 has been written as shown in FIG. 7B (step A7r).

As described above, with the card browsing screen G2 being displayed, each time “Translate/Decide” key 14c is input, the screen is switched to either the card browsing screen G2 on which the front data of the rote card data currently selected has been written or the card browsing screen G2 on which the reverse data has been written.

Then, even in a state where the card browsing screen G2 on which the front data item “account” 27a1f in rote card data item 27a1 has been written is displayed as shown in FIG. 7D, the screen is switched to either the card browsing screen G2 on which the front data item 27a2f in the next rote card data item 27a2 has been written or the card browsing screen G2 on which the front data item 27a0f in the preceding rote card data item 27a0 has been written, depending on the input of a cursor key 14d (“→” or “←”) (YES in step A9f→A10f).

By carrying out the above series of rote card browsing processes (step A1 to step A10r (A10f)), a rote card data item desired by the user can be selected from all the rote card data items 27a, 27b, 27c, . . . registered in the rote card registering process. Then, the user can browse the rote card data, while changing its front data to its reverse data or vice versa freely.

(Rote Card Dictation Test Process)

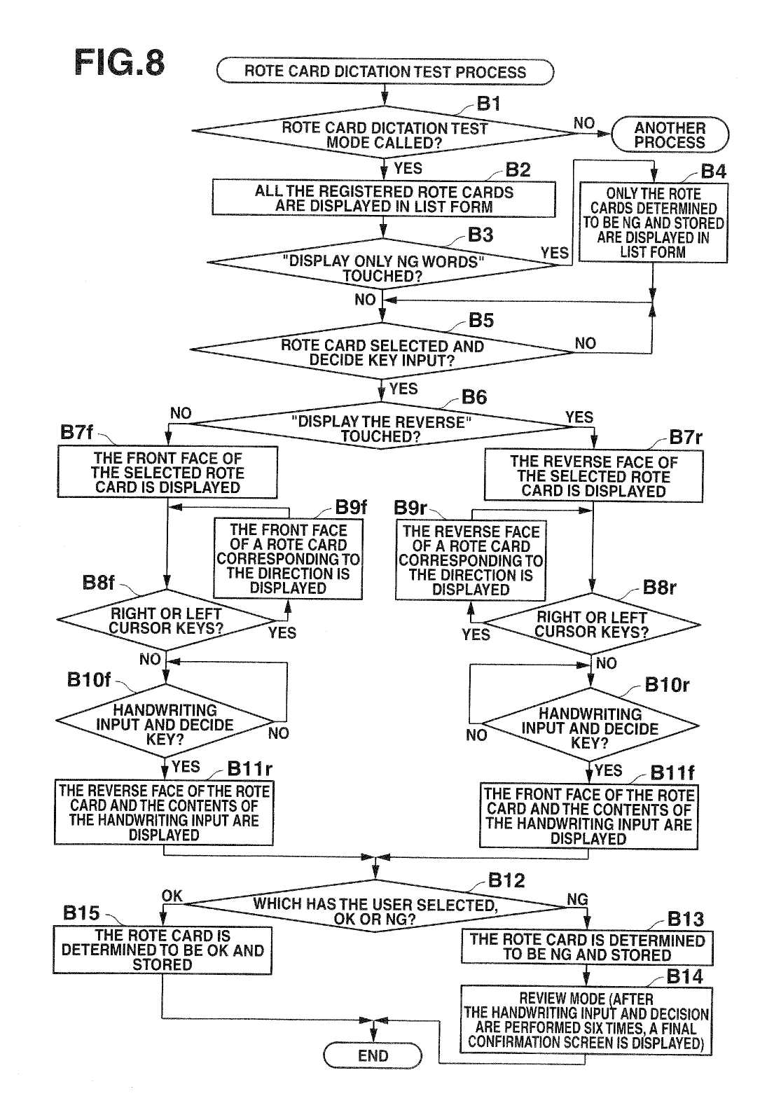

FIG. 8 is a flowchart to help explain a rote card dictation test process in the electronic dictionary device 10 with the handwriting input function.

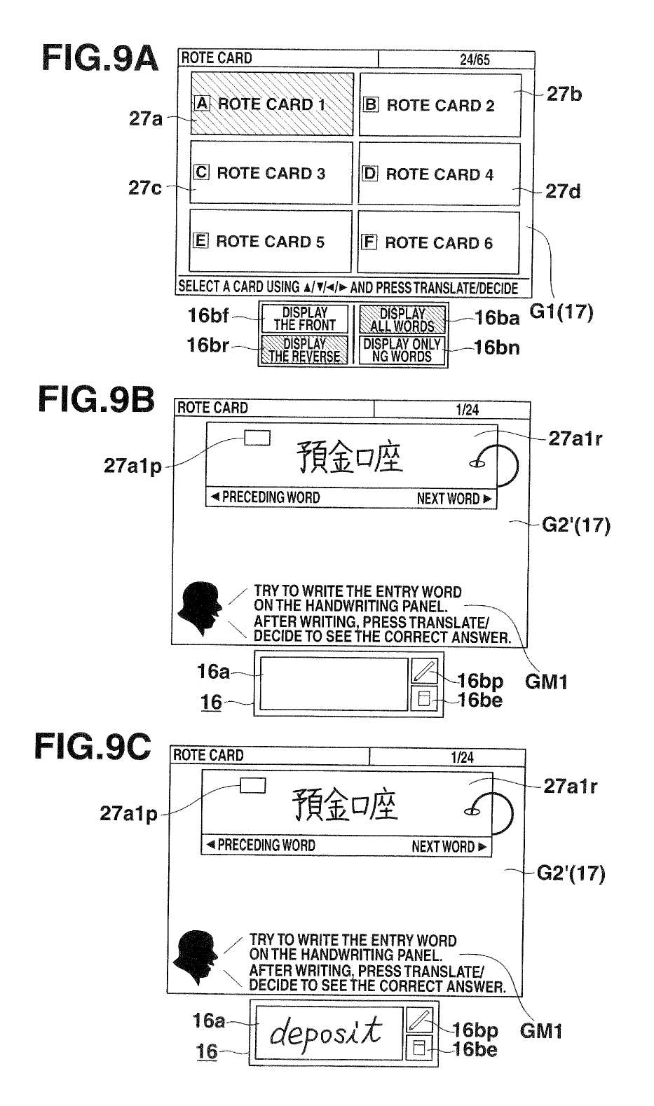

FIGS. 9A to 9C show display operation 1 to display operation 3 corresponding to a user operation in the rote card dictation test process in the electronic dictionary device 10 with the handwriting input function.

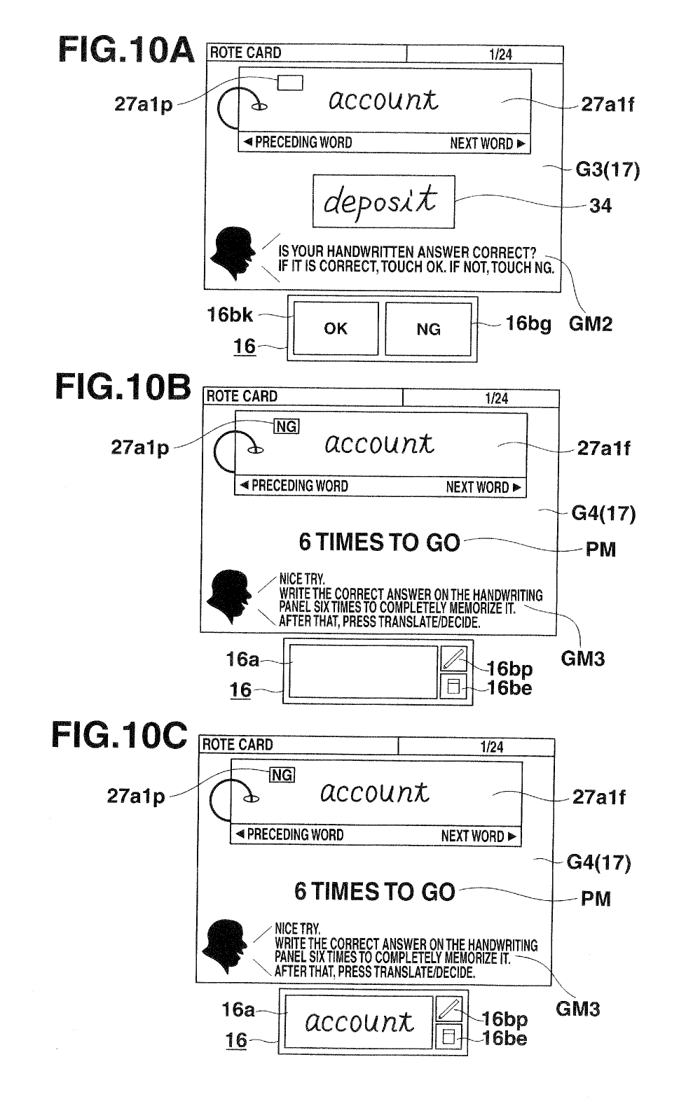

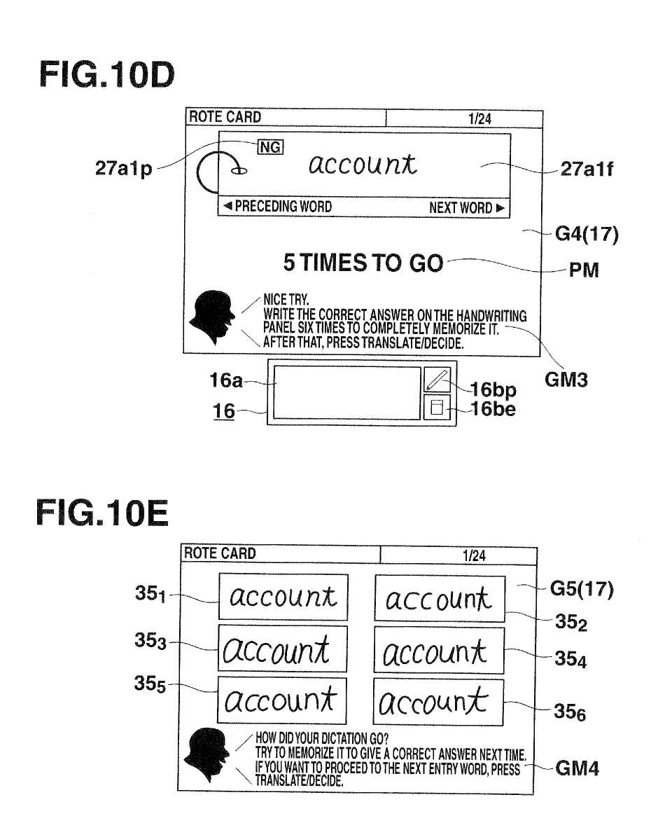

FIGS. 10A to 10E show display operation 4 to display operation 8 corresponding to a user operation in the rote card dictation test process in the electronic dictionary device 10 with the handwriting input function.

When the rote card dictation test mode is selected according to the key input at the input unit 14 on a menu selection screen (not shown) displayed on the touch panel display unit 17 (step B1), all the rote card data items 27a, 27b, 27c, . . . registered in the RAM 23 are read as in the initial display process of the rote card browsing process. Then, a rote card list screen G1 where the rote card data items 27a, 27b, 27c, . . . are used as entries, “Rote card 1,” “Rote card 2,” “Rote card 3,” . . . is displayed on the touch panel display unit 17 as shown in FIG. 9A (step B2).

The series of processes in step B2 to step B9r (B9f) in the rote card dictation test process are almost the same as the series of processes in step A2 to step A7r (A7f)→step A9r (A9f), A10r (A10f) in the rote card browsing process (see FIG. 6). Accordingly, the desired rote card data can be selected according to a user operation and a target card browsing screen G2′ on which either the front data or reverse data in the desired rote card data has been written can be displayed.

However, in the rote card dictation test process, it is impossible to switch between the front data and reverse data in the currently selected rote card data and display either one according to the input of “Translate/Decide” key 14c (step A8r→step A7f (A8f→A7r)). The switching between the front data and reverse data could be performed in the determination process in step A8r (A8f) in the rote card browsing process (see FIG. 6).

That is, by the processes in step B1 to step B9r corresponding to a user operation, a target card browsing screen G2′ on which the reverse data item [symbol] 27a1r in the registered rote card data item 27a1 has been written is displayed on the touch panel display unit 17 as shown in FIG. 9B.

At this time, at the lower end of the target card browsing screen G2′, a dictation test message GM1 (“Try to write the entry word on the handwriting panel. After writing, press Translate/Decide to see the correct answer”) is displayed. Accordingly, the pen input unit 16 is set in the handwriting input unit 16a and goes into a handwritten character (or answer) input waiting state where “Pen” button 16bp and “Eraser” button 16be are displayed in a part of the right end (step B10r).

Here, when the user writes as an answer on the handwriting input unit 16a an entry word (e.g., “deposit”) considered to correspond to the reverse data item [symbol] 27a1r in rote card data item 17a1 displayed on the target card browsing screen G2′ as shown in FIG. 9C and inputs “Translate/Decide” key 14c (YES in step B10r), the touch panel display unit 17 displays a right-wrong decision screen G3 where the front data item “account” 27a1f in rote card data item 27a1 is compared with the handwritten character data “deposit” 34 as the answer input by the user on the handwriting input unit 16a as shown in FIG. 10A (step B11f).

With the right-wrong decision screen G3 being displayed, “OK” button 16bK and “NG” button 16bG are displayed as the multifunction touch input unit 16b on the pen input unit 16. Then, at the lower end of the right-wrong decision screen G3, a message GM 2 is displayed which is for prompting the user to determine whether the handwritten character data “deposit” 34 input as an answer by the user is correct and, if it is correct, displaying “OK” button 16bK and, if it is incorrect, displaying “NG” button 16bG.

Since the processes in step B7f to step B11r are the same as the processes in step B7r to step B11f, except that the front data and the reverse data are treated reversely, a detailed explanation of them will be omitted. Specifically, in the processes in step B7f to step B11r, a target card browsing screen G2′ on which the front data (or entry word) in the rote card data selected according to a user operation has been written is displayed on the touch panel display unit 17. Thereafter, when the user writes explanatory information considered to correspond to the front data (or entry word) in the rote card data on the handwriting input unit 16a, a right-wrong decision screen G3 is displayed which causes the reverse data (or explanatory information) in the rote card data to be compared with the handwritten character data (or explanatory information) 34 input by the user on the handwriting input unit 16a.

In a state where the right-wrong decision screen G3 where the front data item “account” 27a1f in rote card data item 27a1 is compared with the handwritten character data “deposit” 34 input as the answer by the user on the handwriting input unit 16a as shown in FIG. 10A is displayed on the touch panel display unit 17, when the user inputs “NG” button 16bG displayed on the pen input unit 16 because the front data item “account” 27a1f does not coincide with the handwritten character data item “deposit” (NG in step B12), OK/NG information item 27a1p indicating rote NG is added to the rote card data item 27a1. Then, the resulting data item 27a1 is stored in the RAM 23 (step B13).

Then, a review mode process is executed which allows the user to review the front data item (entry word) “account” 27a1f corresponding to the reverse data item (explanatory information) [symbol] 27a1r in the rote card data item 27a1 determined to be incorrect in the latest test process (step B14).

In the review mode process (step B14), an NG card review screen G4 is displayed on the touch panel display unit 17 as shown in FIG. 10B. On the NG card review screen G4, the front data item (or entry word) “account” 27a1f in the rote card data item 27a1 determined to be incorrect, the number of times PM the user is allowed to repeatedly write the front data item “account” 27a1f being 6, and the message “Nice try. Press Translate/Decide after having written on the handwriting panel” GM3 have been written.

When the user inputs the handwritten character data item “account” learned from the front data item (entry word) 27a1f to the handwriting input unit 16a as shown in FIG. 10C and then inputs “Translate/Decide” key 14c, the number of repetitions PM is decremented by one each time as shown in FIG. 10D.

Then, when the user has input the handwritten character data “account” and input “Translate/Decide” key 14c six times according to the NG card review screen G4, a final confirmation screen G5 is displayed on the touch panel display unit 17 as shown in FIG. 10E. On the final confirmation screen G5, the six handwritten character data items “account” 351 to 356 have been written in list form, and further, the final confirmation message “How did your dictation go? If you want to proceed to the next entry word, press Translate/Decide” GM4 has been written.

On the other hand, when the user inputs “OK” button 16bK displayed on the pen input unit 16 because the front data item “account” 27a1f in rote card data item 27a1 written on the right-wrong decision screen G3 coincides with the handwritten character data 34 input as an answer by the user (OK in step B12), OK/NG information 27a1p indicating rote OK is added to the rote card data item 27a1 and the resulting data item is stored in the RAM 23 (step B15).

By carrying out the series of rote card dictation test processes (step B1 to step B15), a rote card data item desired by the user can be selected as a test target from all the rote card data items 27a, 27b, 27c, . . . registered in the rote card registering process, thus it is possible to give a dictation test on the reverse data (explanatory information) corresponding to the front data (entry word) or a dictation test on the front data (entry word) corresponding to the reverse data (explanatory information).

Then, if the result of the dictation test has shown a wrong answer (rote NG), a review mode process is executed, which enables the user to learn the rote card data more effectively. In the review mode process, the user is prompted to repeatedly write the reverse data (explanatory information) or the front data (entry word) in the rote card data determined to be incorrect.

Accordingly, with the electronic dictionary device 10 with the handwriting input function configured as described above, in a state where an explanatory information display screen G corresponding to an entry word desired by the user is displayed on the touch panel display unit 17, front area 32f and reverse area 32r of a rote card to be created are displayed on the explanatory information display screen G. Then, the front area 32f and reverse area 32r of the rote card are selected sequentially with the cursor C and handwritten character data serving as an entry word and handwritten character data serving as explanatory information corresponding to the entry word are input at the handwriting input unit 16a. Then, the handwritten character data serving as the handwritten entry word and the handwritten character data serving as the explanatory information are displayed in the front area 32f and reverse area 32r, respectively, and are caused to correspond to the front data item 27a1f and reverse data item 27a1r in a single rote card data item 27a1, respectively. The resulting data items are registered in the RAM 23. Then, the plurality of rote card data items 27a, 27b, . . . registered are displayed in list form on the rote card list screen G1. According to a user operation, the desired rote card data item 27a is selected and the screen is switched suitably between its front data item (entry word) 27a1f and reverse data item (explanatory information) 27a1r. This enables the user to write and register character data to be used as the front data (entry word) and reverse data (explanatory information) in rote card data, while referring to the entry word and its explanatory information retrieved from the dictionary. Moreover, the user can read and browse the registered rote card data freely, achieving a high learning effect.

Furthermore, with the electronic dictionary device 10 with the handwriting input function, when browsing the plurality of rote card data items 27a, 27b, . . . displayed in list form on the rote card list screen G1, the user can select the desired rote card data item 27a suitably by touching the item with a pen or inputting a cursor key 14d and switch between the front data item 27a1f and reverse data item 27a1r in the selected rote card data item 27a1 according to the input of “Translate/Decide” key 14c. Then, the currently-selected rote card data item 27a1 can be switched to either the preceding or following registered rote card data items 27a0 or 27a2 according to the input of the cursor keys “←” and “→” 14d. Then, the newly selected one is displayed. This enables the user to freely select, display, and browse the front data or reverse data in any one of the plurality of registered rote card data items.

Furthermore, in the rote card dictation mode of the electronic dictionary device 10 with the handwriting input function, in a state where either the front data item (entry word) 27a1f or reverse data item (explanatory information) 27a1r in the desired rote card data item 27a1 is displayed on the touch panel display unit 17, when handwritten character data (explanatory information or entry word) is input at the handwriting input unit 16a as an answer corresponding to one of the front data item and reverse data item (entry word or explanatory information), the right-wrong decision screen G3 is displayed on the touch panel display unit 17. On the right-wrong decision screen G3, the other (correct answer) of the front data item and reverse data item in the rote card data item 27a1 is compared with the handwritten character data (answer). Here, when “OK” button 16bK or “NG” button 16bG displayed on the pen input unit 16 is touched, information 27a1p indicating rote OK or rote NG is added to the rote card data item 17a1 and the resulting item is stored in the RAM 23. In the rote card dictation test mode, when “Display only NG Words” button 16bn displayed on the pen input unit 16 has been touched, only the rote card data to which rote NG information has been added is selected and displayed in list form on the rote card list screen G1. This enables the user to easily select and display solely the rote card data incompletely memorized and learn dictation intensively.

Moreover, in the rote card dictation test mode, when “NG” button 16bG displayed on the pen input unit 16 has been touched, an NG card review screen G4 is displayed. On the NG card review screen G4, the other data item (correct answer) in the rote card data item 27a1 displayed on the right-wrong decision screen G3 at that time and the number of times PM the user is allowed to write the other data item (correct answer) for review have been written. The handwriting input unit 16a accepts the input of handwritten characters repeatedly as many times as the number of times RM for review. This enables the user to repeatedly write the front data (entry word) or reverse data (explanatory information) in rote card data determined to be incorrect and learn the data effectively.

With the electronic dictionary device 10 with the handwriting input function of the embodiment, rote card data items 27a, 27b, . . . created in the rote card creation mode are registered in such a manner that they correspond to the entry words on the explanatory information display screen G displayed in parallel with the process of creating rote card data items. Then, in the rote card browsing mode, when a card browsing screen G2 on which the front data item (entry word) or reverse data item (explanatory information) in the desired rote card data item 27a have been written is displayed, an explanatory information display screen G for the entry words registered so as to correspond to the rote card data items is also displayed. This enables the user to look at dictionary information, including entry words and explanatory information related to the contents of the rote card data, while browsing the described rote card data.

Furthermore, in the rote card dictation test process, the user is allowed to determine whether an answer input by the user is correct. In contrast, the electronic dictionary device 10 may be provided with a character recognition function, thereby making it possible to automatically determine whether an answer input by the user is correct.

According to the present invention, it is possible to provide an electronic dictionary device with a handwriting input function capable of creating handwritten rote cards in a state where an entry word and its explanatory information in dictionary data are displayed.

It is to be understood that the present invention is not limited to the specific embodiments described above and that the invention can be embodied with the components modified without departing from the spirit and scope of the invention. The invention can be embodied in various forms according to the appropriate combinations of the components disclosed in the embodiments described above. For example, some components may be deleted from all components shown in the embodiments. Further, the components in different embodiments may be used appropriately in combination.

What is claimed is:

1. An electronic dictionary device with a handwriting input function, comprising:
a dictionary data storage means which stores a plurality of entry words and explanatory information on each of the plurality of entry words in such a manner that the former correspond to the latter;
a dictionary information display control means which displays on a display unit an arbitrary one selected by the user from the plurality of entry words and explanatory information corresponding to the entry word stored in the dictionary data storage means;
a handwriting input acceptance means which accepts a handwriting input corresponding to a user operation in a state where the dictionary information display control means has displayed on the display unit an arbitrary entry word and explanatory information corresponding to the entry word;
a set information storage means which stores set information created by causing a plurality of pieces of handwriting input information accepted by the handwriting input acceptance means to correspond to one another; and
a set information display control means which displays on the display unit one piece of handwriting input information included in the set information stored in the set information storage means and then displays on the display unit another piece of handwriting input information included in the set information according to a user operation.

2. The electronic dictionary device with a handwriting input function according to claim 1, wherein the display unit is a touch panel display unit,
the electronic dictionary device further comprises rote card display control means which displays the front face and reverse face of a rote card on the display unit,
the handwriting input acceptance means causes a handwriting input unit to accept a handwriting input corresponding to a user operation as a handwriting input to the front face or reverse face of the rote card according to a touch operation on the front face or reverse face of the rote card displayed on the display unit by the rote card display control means,
the electronic dictionary device further comprises an input information display control means which displays handwriting input information on each of the front face and reverse face of the rote card accepted by the handwriting input acceptance means on the front face and reverse face of the rote card displayed on the display unit by the rote card display control means, respectively, and
the set information storage means stores the handwriting input information displayed on each of the front face and reverse face of the rote card by the input information display control means in the form of rote card information composed of the handwriting input information on the front side and that on the reverse side caused to correspond to each other.

3. The electronic dictionary device with a handwriting input function according to claim 2, further comprising:
a dictation test acceptance means which causes a handwriting input unit to accept a handwriting input corresponding to a user operation in a state where handwriting input information on the front face or reverse face included in the rote card information is displayed on the display unit by the set information display control means;
a comparison display control means which displays handwriting input information accepted by the dictation test acceptance means together with handwriting input information on the reverse face on the display unit when the set information display control means has displayed handwriting input information on the front face of the rote card, and displays the accepted handwriting input information together with handwriting input information on the front face on the display unit when the set information display control means has displayed handwriting input information on the reverse side of the rote card;
a decision acceptance means which accepts a decision on a correct answer or an incorrect answer corresponding to a user operation after the comparison display control means displays handwriting input information accepted by the dictation test acceptance means together with handwriting input information on the reverse face or front face of the rote card on the display unit; and
a decision information storage means which causes decision information on a correct answer or an incorrect answer accepted by the decision acceptance means -to correspond to the rote card information displayed on the display unit as a result of the acceptance of a handwriting input by the dictation test acceptance means and stores the resulting decision information,
wherein the set information display control means includes an incorrect-answer card information display control means which displays on the display unit only the rote card information stored in the set information storage means so as to correspond to decision information on an incorrect answer stored in the decision information storage means.

4. The electronic dictionary device with a handwriting input function according to claim 3, further comprising: a review acceptance means which, when the decision acceptance means has accepted a decision on an incorrect answer, causes the handwriting input unit to accept a handwriting input corresponding to a user operation a plurality of times in a state where handwriting input information on the reverse face or front face of the rote card is displayed on the display unit.

5. The electronic dictionary device with a handwriting input function according to claim 4, wherein the set information display control means displays on the display unit one piece of handwriting input information selected according to a user operation from a plurality of pieces of handwriting input information included in set information stored in the set information storage means and then displays on the display unit another piece of handwriting input information included in the set information according to a user operation.

6. The electronic dictionary device with a handwriting input function according to claim 5, wherein the set information storage means includes an entry-word corresponding set information storage means which causes set information obtained by causing a plurality of pieces of handwriting input information accepted by the handwriting input acceptance means to correspond to one another to correspond to an entry word displayed on the display unit as a result of the acceptance of a handwriting input by the handwriting input acceptance means and which stores the resulting set information.

7. A program product causing a computer with a display unit to function as
a dictionary data storage means which stores a plurality of entry words and explanatory information on each of the plurality of entry words in such a manner that the former correspond to the latter;
a dictionary information display control means which displays on a display unit an arbitrary one selected by the user from the plurality of entry words and explanatory information corresponding to the entry word stored in the dictionary data storage means;
a handwriting input acceptance means which accepts a handwriting input corresponding to a user operation in a state where the dictionary information display control means has displayed on the display unit an arbitrary entry word and explanatory information corresponding to the entry word;
a set information storage means which stores set information created by causing a plurality of pieces of handwriting input information accepted by the handwriting input acceptance means to correspond to one another; and
a set information display control means which displays on the display unit one piece of handwriting input information included in the set information stored in the set information storage means and then displays on the display unit another piece of handwriting input information included in the set information according to a user operation.

8. The program product according to claim 7, wherein the display unit is a touch panel display unit,
the program product further causes the computer to function as a rote card display control means which displays the front face and reverse face of a rote card on the display unit,
the handwriting input acceptance means causes a handwriting input unit to accept a handwriting input corresponding to a user operation as a handwriting input to the front face or reverse face of the rote card according to a touch operation on the front face or reverse face of the rote card displayed on the display unit by the rote card display control means,
the program product further causes the computer to function as an input information display control means which displays handwriting input information on each of the front face and reverse face of the rote card accepted by the handwriting input acceptance means on the front face and reverse face of the rote card displayed on the display unit by the rote card display control means, respectively, and
the set information storage means stores the handwriting input information displayed on each of the front face and reverse face of the rote card by the input information display control means in the form of rote card information composed of the handwriting input information on the front side and that on the reverse side caused to correspond to each other.

9. The program product according to claim 8, further causing the computer to function as
a dictation test acceptance means which causes a handwriting input unit to accept a handwriting input corresponding to a user operation in a state where handwriting input information on the front face or reverse face included in the rote card information is displayed on the display unit by the set information display control means;
a comparison display control means which displays handwriting input information accepted by the dictation test acceptance means together with handwriting input information on the reverse face on the display unit when the set information display control means has displayed handwriting input information on the front face of the rote card, and displays the accepted handwriting input information together with handwriting input information on the front face on the display unit when the set information display control means has displayed handwriting input information on the reverse side of the rote card;
a decision acceptance means which accepts a decision on a correct answer or an incorrect answer corresponding to a user operation after the comparison display control means displays handwriting input information accepted by the dictation test acceptance means together with handwriting input information on the reverse face or front face of the rote card on the display unit; and
a decision information storage means which causes decision information on a correct answer or an incorrect answer accepted by the decision acceptance means to correspond to the rote card information displayed on the display unit as a result of the acceptance of a handwriting input by the dictation test acceptance means and stores the resulting decision information,
wherein the set information display control means includes an incorrect-answer card information display control means which displays on the display unit only the rote card information stored in the set information storage means so as to correspond to decision information on an incorrect answer stored in the decision information storage means.

10. The program product according to claim 9, further causing the computer to function as
a review acceptance means which, when the decision acceptance means has accepted a decision on an incorrect answer, causes the handwriting input unit to accept a handwriting input corresponding to a user operation a plurality of times in a state where handwriting input information on the reverse face or front face of the rote card is displayed on the display unit.

11. The program product according to claim 10, wherein the set information display control means displays on the display unit one piece of handwriting input information selected according to a user operation from a plurality of pieces of handwriting input information included in set information stored in the set information storage means and then displays on the display unit another piece of handwriting input information included in the set information according to a user operation.

12. The program product according to claim 11, wherein the set information storage means includes an entry-word corresponding set information storage means which causes set information obtained by causing a plurality of pieces of handwriting input information accepted by the handwriting input acceptance means to correspond to one another to correspond to an entry word displayed on the display unit as a result of the acceptance of a handwriting input by the handwriting input acceptance means and which stores the resulting set information.

13. An electronic dictionary device with a handwriting input function, comprising:
a display unit;
a handwriting input unit which accepts a handwriting input corresponding to a user operation;
a storage unit which stores a plurality of entry words and explanatory information on each of the plurality of entry words in such a manner that the former correspond to the latter; and
a control unit which
causes a display unit to display an arbitrary entry word selected by the user from the plurality of entry words and explanatory information corresponding to the entry word stored in the storage unit,
causes the handwriting input unit to accept a handwriting input corresponding to a user operation in a state where the arbitrary entry word and explanatory information corresponding to the entry word are displayed on the display unit,
causes the storage unit to store set information created by causing a plurality of pieces of handwriting input information accepted by the handwriting input unit to correspond to one another, and
causes the display unit to display one piece of handwriting input information included in the set information stored in the storage unit and then display another piece of handwriting input information included in the set information according to a user operation.

14. The electronic dictionary device with a handwriting input function according to claim 13, wherein the display unit is a touch panel display unit, and
the control unit
causes the display unit to display the front face or reverse face of a rote card,
causes the handwriting input unit to accept a handwriting input corresponding to a user operation as a handwriting input to the front face or reverse face of the rote card according to a touch operation on the front face or reverse face of the rote card displayed on the display unit,
causes the display unit to display handwriting input information on each of the front face and reverse face of the rote card accepted by the handwriting input unit on the front face and reverse face of the rote card displayed on the display unit, respectively, and
causes the storage unit to store the handwriting input information displayed on each of the front face and reverse face of the rote card in the form of rote card information composed of the handwriting input information on the front side and that on the reverse side caused to correspond to each other.

15. The electronic dictionary device with a handwriting input function according to claim 14, wherein the control unit
causes a handwriting input unit to accept a handwriting input corresponding to a user operation in a state where handwriting input information on the front face or reverse face included in the rote card information is displayed on the display unit,
causes the display unit to display the handwriting input information accepted by the handwriting input unit together with handwriting input information on the reverse face when handwriting input information on the front face of the rote card has been displayed, and display the accepted handwriting input information together with handwriting input information on the front face when handwriting input information on the reverse side of the rote card has been displayed,
accepts a decision on a correct answer or an incorrect answer corresponding to a user operation after the handwriting input information is displayed together with handwriting input information on the reverse face or front face of the rote card on the display unit; and
causes the accepted decision information on a correct answer or an incorrect answer to correspond to the rote card information displayed on the display unit as a result of the acceptance of the handwriting input and stores the resulting decision information, and
causes the display unit to display only the rote card information stored in the storage unit so as to correspond to decision information on an incorrect answer stored in the storage unit.

16. The electronic dictionary device with a handwriting input function according to claim 15, wherein the control unit, when a decision on an incorrect answer has been accepted, causes the handwriting input unit to accept a handwriting input corresponding to a user operation a plurality of times in a state where handwriting input information on the reverse face or front face of the rote card is displayed on the display unit.

17. The electronic dictionary device with a handwriting input function according to claim 16, wherein the control unit causes the display unit to display one piece of handwriting input information selected according to a user operation from a plurality of pieces of handwriting input information included in the stored set information and then causes the display unit to display another piece of handwriting input information included in the set information according to a user operation.

18. The electronic dictionary device with a handwriting input function according to claim 17, wherein the control unit causes set information composed of the accepted pieces of handwriting input information caused to correspond to one another to correspond to an entry word displayed on the display unit as a result of the acceptance of the handwriting input and stores the resulting set information.
